(19) United States
(12) Patent Application Publication
(10) Pub. No.: US 2007/0141309 A1
(43) Pub. Date: Jun. 21, 2007

(54) Method of creating an addition to an existing building

(76) Inventor: Charles R. Weir, Westerville, OH (US)

Correspondence Address: OWENS CORNING, 2790 COLUMBUS ROAD, GRANVILLE, OH, 43023, US

(21) Appl. No.: 11/648,076

(22) Filed: Dec. 30, 2006

Related U.S. Application Data
(63) Continuation-in-part of application No. 10/789,229, filed on Feb. 27, 2004.

(51) Int. Cl. B41M 5/00

(52) U.S. Cl. 428/195.1

(57) ABSTRACT

A method of adding an additional room to an existing building includes selecting an exterior wall to be a common wall between the existing building and the additional room, adding the additional room to the existing building along the common wall, removing exterior layers of the common wall to expose a core, and attaching an acoustic finishing system to the core.

### RELATED APPLICATIONS

This application is a continuation-in-part application of U.S. patent application Ser. No. 10/789,229, filed on Feb. 27, 2004 entitled, “Room finishing system”, which is incorporated herein by reference in its entirety.

### TECHNICAL FIELD

This invention relates to building construction and specifically to the addition of rooms to an existing building.

### BACKGROUND OF THE INVENTION

The addition of rooms to an existing building is known in the art. For example, a sunroom can be added to an existing residential dwelling. Typically, a doorway is either already part of the existing building or a doorway is installed. The additional room is then constructed attached to the existing building. The additional room will typically use at least one wall of the existing building as a wall of the additional room. In addition to this one or more common wall, the additional room is constructed with new walls, floor and ceiling. The additional room also has a roof. When the additional room is a sunroom, a large portion of the walls is comprised of windows.

It would be advantageous if improvements could be made to the process of adding a room to a building.

### SUMMARY OF THE INVENTION

According to this invention there is provided a method of adding an additional room to an existing building. The method includes selecting an exterior wall to be a common wall between the existing building and the additional room, adding the additional room to the existing building along the common wall, removing exterior layers of the common wall to expose a core, and attaching an acoustic finishing system to the core.

According to this invention there is also provided a method of adding an additional room to an existing building. The method includes selecting an exterior wall to be a common wall between the existing building and the additional room, adding the additional room to the existing building along the common wall, and attaching an acoustic finishing system to the common wall.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view, partially cut away, of an existing building and a sunroom addition demonstrating one embodiment of the invention.

FIG. 2 is a cross-sectional view in elevation of the common wall of the building of FIG. 1, taken along line 2-2 of FIG. 1.

FIG. 3 is a cross-sectional view in elevation of a building wall according to a second embodiment of the invention.

FIG. 4 is a cross-sectional view in elevation of a building wall according to a third embodiment of the invention.

FIG. 5 is a cross-sectional view in elevation of an acoustic finishing system that can be used on the common wall.

FIG. 6 is a perspective view of the interior of the sunroom of FIG. 1.

### DETAILED DESCRIPTION OF THE DRAWINGS

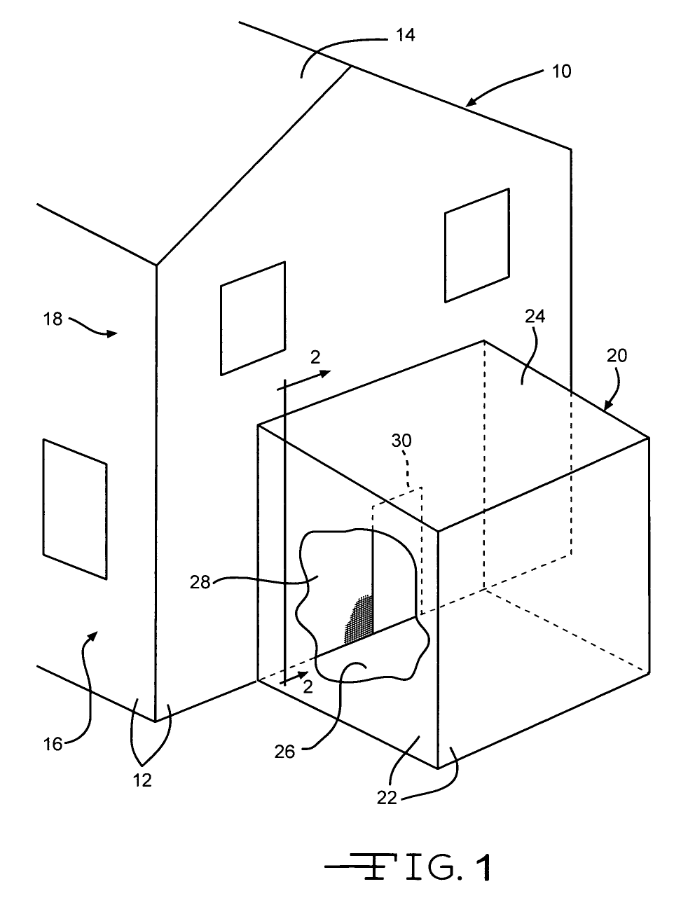

One non-limiting embodiment of the invention is shown in FIG. 1. There is an existing building 10 having existing walls 12 and an existing roof 14. The existing building comprises a first story, shown generally at 16, a second story, shown generally at 18. It should be understood that the invention is not limited to a two-story existing building, nor limited to a residential structure, and this structure is simply used for illustrative purposes.

Attached to the first story 16 of the existing building 10, is an additional room 20. The additional room 20 could be attached to the existing building 10 somewhere other that the first story 16, or it could be attached to multiple stories of the existing building 10. The additional room 20 has addition walls 22, an addition roof 24 and an addition floor 26. One of the addition walls 22 of the additional room 20 is the common wall 28. A doorway 30 communicates between the interior of the existing building 10 and the interior of the additional room. It should be understood that the additional room 20 could have more than one common wall 28 with the existing building, and the additional room could lack a doorway 30 communicating with the interior of the existing building 10.

The existing walls 12, including the common wall 28, are typically composed of several layers. The configuration of the layers in the existing walls 12 can be one of any number of different designs, and there is no single configuration common to all existing buildings. One possible configuration is shown in FIG. 2. The existing configuration of the complete common wall 28 is shown in the second story portion shown in FIG. 2 at 18. The layers comprising the common wall 28 are an interior drywall 32, a vapor barrier 34, building studs 36, sheathing 38, and siding 40.

In practicing the invention, some of the exterior layers of the common wall 28 of the existing building 10 are normally removed to expose a core, indicated generally at 41. This is shown at the first-story portion 16 of the common wall 28 in FIG. 2. A core is any layer or combination of layers sufficient to support an acoustic finishing system 42. The core may be the building studs 36, to which the acoustic finishing system 42 can be attached. A wind barrier layer, such as Tyvek® material, can be positioned between the building studs 36 and the acoustic finishing system 42. Other materials, such as a plastic weather barrier or wall board sheathing such as OSB can also be positioned between the building studs 36 and the acoustic finishing system 42. The finished configuration of the common wall 28, with the exterior layers removed to the core 41 and the acoustic finishing system 42 attached, is shown in the first-story portion of the common wall 28 in FIG. 2 at 16.

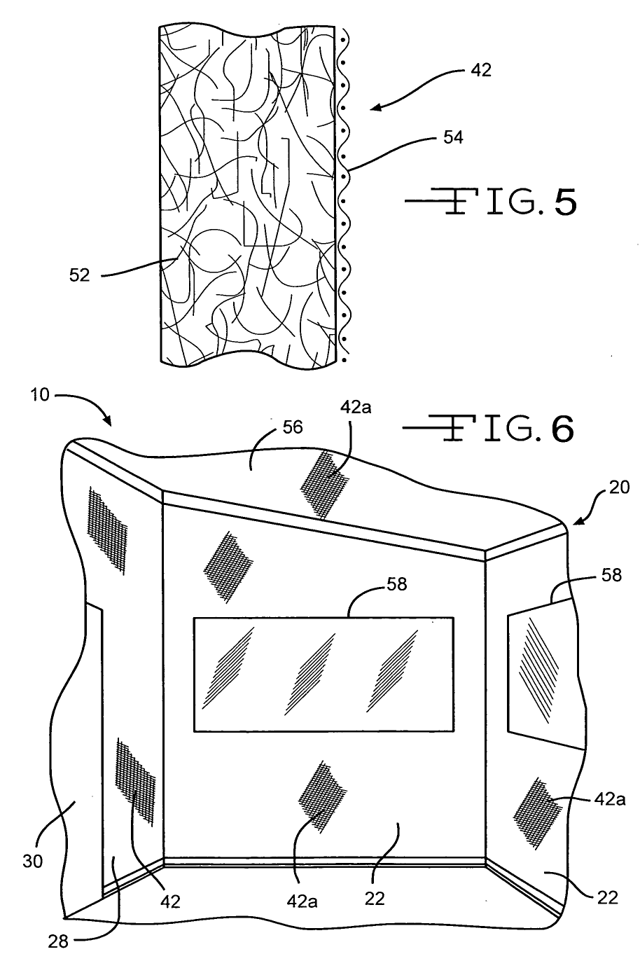

The acoustic finishing system 42 can be comprised of a board 52 to which is attached a decorative fabric 54, as shown in FIG. 5. The board 52 can be a layer of acoustic insulation, such as a fiber glass board, or it can be any other material with desirable acoustic properties. The decorative fabric 54 can be woven or non-woven, and can be made of natural or synthetic fibers, such as polyester fibers. The decorative fabric 54 can be applied to the board 52 by any suitable means such as with an adhesive. Alternatively the decorative fabric 54 can comprise any other suitable finishing system to achieve the desired properties.

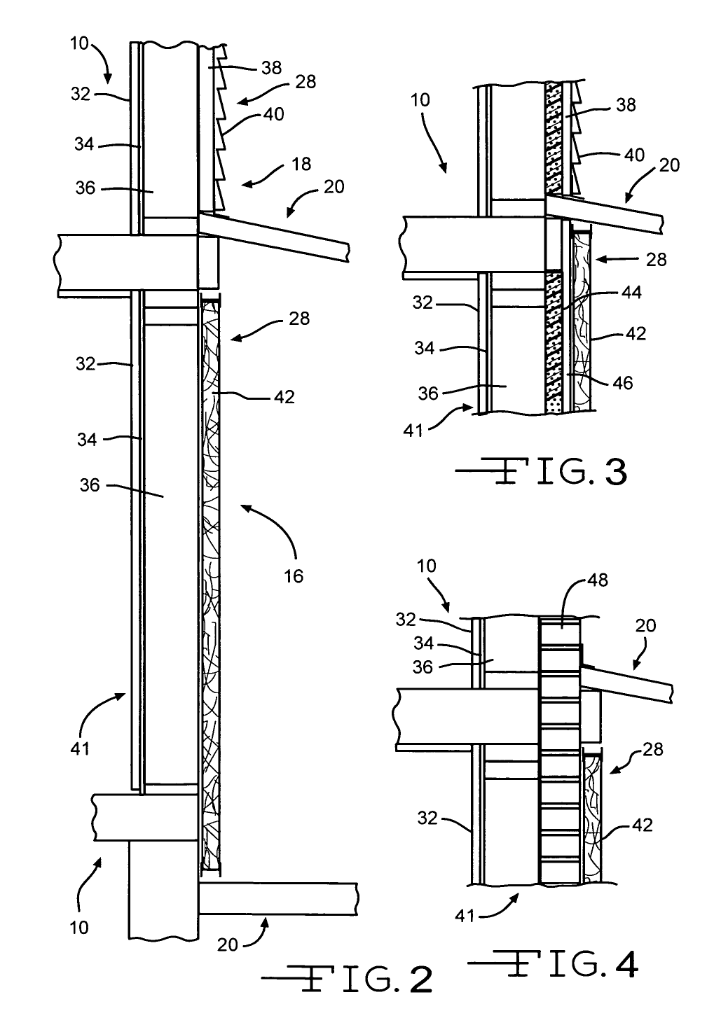

In some cases, it may be desirable to attach an intermediate layer to the core 41 prior to attaching the acoustic finishing system 42. A second embodiment of the invention is shown in FIG. 3. In this illustration, the core 41 of the common wall 28 contains foam insulation 44. In that case, it may be desirable to attach a fire barrier layer 46 between the core and the acoustic finishing system 42. The embodiment shown in FIG. 3 includes drywall as the fire barrier layer 46. It should be understood that other intermediate layers besides drywall can be attached between the core 41 and the acoustic finishing system 42. Any material capable of providing necessary fire protection for the underlying insulation layer 44 could be used as a fire barrier layer 46.

Another embodiment of the invention is shown in FIG. 4. In this embodiment, the acoustic finishing system 42 is applied to the common wall 28 without removing any exterior layers from the common wall 28. When the outermost exterior layer 48 of the existing building 10 is sufficient to support the acoustic finishing system 42, then none of the exterior layers need to be removed. Typically, the acoustic finishing system 42 can be attached directly to stone, brick, stucco, steel and similar types of siding surfaces. In such instances, it may be desirable to use a thinner board as described in the '229 application, so as to minimize the intrusion into the addition.

As shown in FIG. 6, the acoustic finishing system 42 is attached to the common wall 28 between the existing building 10 and the additional room 20. An addition acoustic finishing system 42a is also attached to the addition walls 22, and the addition ceiling 56 of the additional room 20. The addition acoustic finishing system 42a can be the same as the acoustic finishing system 42, or it can be made with a different configuration. Additionally, the addition acoustic finishing system 42a is optional, or may be installed without the wall system 42, and does not have to be installed when practicing this invention.

A common reason to add a room to an existing building is to add a sunroom to a residence. A sunroom provides the residence with more visible access to the outdoors, and accomplishes this by having a large number of windows 58. Without acoustic treatment, the windows 58 on the addition walls 22 and the existing exterior siding material 40 on the common wall 28 would create an environment in which sound is not absorbed, but rather is largely reflected by the walls and windows (such as with brick cladding, siding, drywall, or other materials on the common wall). This can result in a poor acoustic environment, and diminish the ability of the home-owner to enjoy the additional room. In a specific embodiment of the invention, the acoustic finishing system has a Noise Reduction Coefficient (NRC) of at least 0.40 as measured by ASTM test C423. In another specific embodiment of the invention, the acoustic finishing system has a Noise Reduction Coefficient of at least 0.75.

In a specific embodiment of the invention, the finishing system is installed in a removable manner, such as that illustrated in U.S. Pub. No. 2004/0219853 A1 to Weir et al. for a “Room Finishing System”, and in U.S. Pub. No. 2005/0150183 A1 to Hettler et al for an “Insulation System with Variable Position Vapor Barrier”, both of which are expressly incorporated herein by reference in their entireties.

The acoustic finishing system 42 attached to the common wall 28 provides improvements to the additional room 20 by providing an aesthetically-pleasing appearance to the common wall 28, which would otherwise appear similar to the outmost exterior layer of the common wall 28. This improves the speed of installation and flexibility. Furthermore, it can provide the owner access to the interior of the wall to accommodate wiring, speakers, or other modifications. Additionally, the acoustic finishing system 42 provides acoustic benefits. The transmission of sound from the additional room 20 to the existing building 10 is reduced, and the amount of sound reflection within the additional room 20 is reduced, and the r-value of the wall can be maintained or improved. Furthermore, the system provides insulation, potentially improving the comfort and energy efficiency of both the room and the adjacent structure. Furthermore, because the system may be breathable, the relative humidity of the room may be controlled using the system of the adjacent structure.

The principle and mode of operation of this invention have been described in its preferred embodiments. However, it should be noted that this invention may be practiced otherwise than as specifically illustrated and described without departing from its scope. It should also be understood that while the embodiments described suggest a particular order in which steps of the invention are carried out, the order suggested by the described embodiments can be varied from without departing from the scope of the invention. For example, the acoustic finishing system 42 could be attached to the common wall 28 prior to construction of the additional room 20. When introducing elements of the present invention or embodiments of the invention, the articles “a,” “an,” and “the” are intended to mean that there are one or more of the elements. The terms “comprising,” “including,” and “having” are intended to be inclusive and mean that there may be additional elements other than the listed elements.

1. A method of adding an additional room to an existing building, the method comprising:
a) selecting an exterior wall to be a common wall between the existing building and the additional room;
b) adding the additional room to the existing building along the common wall; and
c) attaching an acoustic finishing system to the common wall.

2. The method of claim 1, further comprising the step of removing an exterior layer of the common wall to expose a core, and wherein the step of attaching an acoustic finishing system to the common wall comprises attaching the acoustic finishing system to the exposed core.

3. The method of claim 2, wherein the core comprises one of building studs, wallboard, a wind barrier, and a combination thereof.

4. The method of claim 1, wherein the acoustic finishing system has a Noise Reduction Coefficient of at least 0.40.

5. The method of claim 2, wherein the acoustic finishing system has a Noise Reduction Coefficient of at least 0.75.

6. The method of claim 2, wherein the core includes foam insulation and the method further comprises the step of applying a fire barrier layer to the core before attaching the acoustic finishing system.

7. The method of claim 6, wherein the fire barrier layer is drywall.

8. The method of claim 1, further comprising attaching an acoustic finishing system to a ceiling of the additional room.

9. The method of claim 2, further comprising attaching an acoustic finishing system to a ceiling of the additional room.

10. The method of claim 1, further comprising attaching the acoustic finishing system to additional walls of the additional room.

11. The method of claim 2, wherein the step of removing the exterior layer of the common wall includes removing one of a layer of siding, a layer of brick, a layer of acoustic insulation, sheathing, a decorative layer, and a combination thereof.

12. The method of claim 11, wherein the exterior layer includes the decorative layer which further comprises a decorative fabric.

13. The method of claim 12, wherein the acoustic insulation has a Noise Reduction Coefficient of at least 0.40.

14. A method of adding an additional room to an existing building, the method comprising:
a) selecting an exterior wall to be a common wall between the existing building and the additional room;
b) adding the additional room to the existing building along the common wall; and
c) attaching an acoustic finishing system one of the common wall and a ceiling.

15. The method of claim 14, wherein the acoustic finishing system has a Noise Reduction Coefficient of at least 0.40.

16. The method of claim 14, wherein the acoustic finishing system is attached to the common wall and to the ceiling of the additional room.

17. The method of claim 16, further comprising attaching the acoustic finishing system to additional walls of the additional room.

18. The method of claim 14, wherein the acoustic finishing system comprises at least one layer of acoustic insulation and a decorative layer.

19. The method of claim 14, wherein the acoustic finishing system is removable.

20. An addition room for attachment to an existing building, comprising:
a) an exterior wall to be a common wall between the existing building and the addition room;
b) adding the addition room to the existing building along the common wall; and
c) an acoustic finishing system attached to the common wall.

21. The addition room of claim 20, wherein the acoustic finishing system has a Noise Reduction Coefficient of at least 0.40.
